(19) United States
(12) Patent Application Publication
(10) Pub. No.: US 2026/0184019 A1
(43) Pub. Date: Jul. 2, 2026

(54) METHOD FOR PROVIDING A PROCESS INSTRUCTION FOR ADDITIVE MANUFACTURING, BY WAY OF MACHINE LEARNING

(71) Applicant: 1000 KELVIN GMBH, Berlin (DE)

(72) Inventors: Katharina EISSING, Berlin (DE); Omar FERGANI, Berlin (DE)

(21) Appl. No.: 19/130,051

(22) PCT Filed: Nov. 10, 2023
(86) PCT No.: PCT/EP2023/081430

§ 371 Date: May 14, 2025

(30) Foreign Application Priority Data
Nov. 14, 2022 (DE) 10 2022 130 090.0

(51) Int. Cl. B29C 64/386; B33Y 50/00; G05B 19/4099

(52) U.S. Cl. CPC B29C 64/386; B33Y 50/00; G05B 19/4099; G05B 2219/33034; G05B 2219/49023

(57) ABSTRACT

The invention relates to a method for providing a process instruction for the additive manufacture of a component, including the method steps: reading in geometrical data of the component; producing a layer structure of a building structure, the building structure comprising the component; and generating a process instruction for the additive manufacturing of the building structure, a machine learning algorithm being used to generate the process instruction.

The invention relates to a method for providing a process instruction for the additive manufacture of a component with the method steps of reading in geometrical data of the component, producing a layer structure of a building structure, wherein the building structure comprises the component, and generating a process instruction for the additive manufacturing of the building structure, wherein an machine learning algorithm is used to generate the process instruction.

### PRIOR ART

3D printing or additive manufacturing is a comprehensive term for all manufacturing processes in which material is applied layer by layer to thus create three-dimensional components. The layered construction occurs computer-controlled from one or more liquid or solid materials according to specifications from a CAD/CAM system. The layers can then be broken down into tracks, particularly in direct energy deposition processes. In addition, in so-called hatching, a layer is divided into stripes (hatches) or squares and parallel vectors are distributed within them. With powder bed-based technologies, such as selective laser melting, the component is manufactured without further subdivision of the layers. When building up the workpiece layer by layer, a print head or a laser is usually moved horizontally, i.e. in the X-Y plane, and at the same time material tracks are applied with the print head or laser. Once a layer is completed, the build plate on which the workpiece is manufactured is usually moved vertically downwards, i.e. in the Z direction, and another layer is started. When applying or melting the layers, the workpiece may experience problems such as cracking, deformation and an uneven crystal structure, depending on the type of material applied and the set process parameters (e.g. temperature, feed). In other cases, this can even lead to an entire production process having to be stopped. In the prior art, a process plan is usually created only on the basis of the geometric design of a workpiece. If such a process plan is executed, it may lead to a phenomenon in that a specific portion of the workpiece in a manufacturing process is overheated, for example, and it is difficult to effectively control the temperature of the workpiece. In addition, in the prior art in an additive manufacturing process, it is impossible to change and adapt the process plan, especially during the manufacturing process, once a process plan has been completely created.

It is therefore an object of the invention to provide a method for providing a process instruction for the additive manufacturing of a component, with which an improved process plan for the additive manufacturing of a workpiece is provided.

The object is achieved by means of the method according to the invention for providing a process instruction for the additive manufacturing of a component according to claim 1. Advantageous embodiments of the invention are set out in the following dependent claims.

The method according to the invention for providing a process instruction for the additive manufacturing of a component comprises three steps: In the first step, geometric data of the component is read in.

In the second step, a layer structure of a building structure is created, wherein the building structure comprises the component. From the data set created using the CAD program, a manufacturing data set is generated which contains a preparation of the geometry of the workpiece in layers or slices suitable for additive manufacturing. This transformation of the data is called slicing.

In the third step, a process instruction for the additive manufacturing of the building structure is created, wherein a machine learning algorithm is used to create the process instruction. A process instruction is understood to be data that is made available to an additive manufacturer for the additive manufacture of the building structure. This includes the process parameters for the additive manufacturer as well as the definition of a tool path such as one or more parameters from the group of power of the energy beam, irradiation time of individual vectors, pause time between the irradiation times of individual vectors, traversing speed of the energy beam, change of the hatch distance between the vectors, the vector sequence, the vector length, vector orientation and/or changed geometry of the support structure. The tool path usually consists of a large number of consecutive vectors that are traversed by the additive manufacturer. The process instructions thus define a process control that the additive manufacturer uses to produce a building structure.

For manufacturing reasons, it is necessary in the aforementioned 3D printing processes to support delicate or overhanging structures during the printing process using a support structure. These structures would otherwise collapse due to gravity. Support structures are also sometimes necessary in metal 3D printing, but for different reasons than in plastic-based additive processes. The danger here is less that the model could collapse during printing, but rather to prevent impending warping. Thin regions of the model in particular can bend easily. However, the internal stresses in additive manufacturing are so high that even massive components can warp significantly.

By means of the process instruction, a building structure can be produced which does not overheat in particularly vulnerable regions during the manufacturing process and which has a lower residual stress distribution in the cooled and post-processed state, which is relevant, for example, in the production of turbine blades.

Additive manufacturing processes within the meaning of this application are processes in which the material from which a building structure is to be manufactured is added to the building structure during its creation. The building structure is created in its final form or at least approximately in this form, with subsequent processing then taking place. In particular, the building structure to be manufactured has a support structure that comprises one or more support points. This support structure is removed during post-processing.

The techniques used by an additive manufacturer to produce a component include, for example, extrusion deposition or selective deposition modeling (SDM), techniques such as fused deposition modeling (FDM) and fused filament fabrication (FFF), stereolithography (SLA), polyjet printing (PJP), multijet printing (MJP), selective laser sintering (SLS), selective laser melting (SLM), three-dimensional printing (3DP), techniques such as inkjet printing (CJP), directed energy deposition (DED) and the like.

Fused Filament Fabrication (FFF), also known as Fused Deposition Modeling or Filament Freeform Fabrication, is a 3D printing process that uses a continuous filament made of a thermoplastic material. The filament is fed from a large spool through a movable, heated extruder head of the printer and applied to the growing workpiece. The print head is moved under computer control to define the printed shape. Typically, the head moves in two dimensions to deposit one horizontal plane or layer at a time; the workpiece or print head is then moved vertically a small amount to begin a new layer. The speed of the extruder head can also be controlled to stop and start deposition, creating a discontinuous layer without any filaments or drips between portions.

Directed Energy Deposition (DED) refers to a category of additive manufacturing or 3D printing processes in which powder or wire is fed coaxially to an energy source (usually a laser) to form a molten or sintered layer on a substrate.

Melt filament printing is currently the most popular method for 3D printing, especially in the hobby sector. Other processes such as photopolymerization and powder sintering can produce better results, but are significantly more expensive. The 3D printer head or 3D printer extruder is a part in additive manufacturing by material extrusion that is responsible for melting or softening the raw material and forming it into a continuous profile. A wide variety of filament materials are extruded, including thermoplastics such as acrylonitrile butadiene styrene (ABS), polylactic acid (PLA), polyethylene terephthalate glycol (PETG), polyethylene terephthalate (PET), high impact polystyrene (HIPS), thermoplastic polyurethane (TPU) and aliphatic polyamides (nylon).

The method according to the invention for providing a process instruction for the additive manufacturing of a building structure is computer-aided, wherein the term “computer-aided” is used, for example, in this document in such a way that one computer or several computers carry out at least one method step of the method. Computers can be, for example, personal computers, servers, handheld computer systems, pocket PC devices, mobile devices and other communication devices that can process data in a computer-aided manner, as well as processors and other electronic devices for data processing, which can also be connected to form a network.

The starting point for additive manufacturing is a geometric description of the workpiece using a data set. Using 3D modeling software (e.g. a CAD program), the data set for the building structure of the component to be manufactured is created. The data set contains the three-dimensional geometric data for production using the additive manufacturing process.

The possible machine learning and/or AI algorithms used are described in the following paragraphs.

Random Forest Regression is a machine learning method of ensemble learning. An ensemble of multiple decision trees is combined and used for regression. This is supervised learning.

Gradient boosted trees is another ensemble learning that can be applied for regression and classification. It is associated with supervised learning.

Deep learning (German: multi-layered learning, deep learning or in-depth learning) refers to a method of machine learning. Most deep learning algorithms are deep neural networks (DNNs). They consist of many layers of linear and non-linear processing units, the artificial neurons. The more neurons and layers a neural network contains, the more complex the situations that can be represented.

Another type of deep learning algorithm are decision trees (Random Decision Forests, or RDFs for short). They also consist of many layers, but instead of neural structures, RDFs are constructed from decision trees and output a statistical average (mode or mean) of the predictions of the individual trees.

Deep learning is used wherever large amounts of data are examined for patterns and trends. In the context of AI, this happens, for example, in the following areas: facial, object or speech recognition.

A convolutional neural network (CNN or ConvNet) is an artificial neural network. It is a concept in the field of machine learning inspired by biological processes. Convolutional neural networks are used in numerous artificial intelligence technologies, primarily in the machine processing of image or audio data.

Recurrent or feedback neural networks are neural networks which, in contrast to feedforward networks, are characterized by connections between neurons in one layer and neurons in the same or a previous layer. In the brain, this is the preferred way of interconnecting neural networks, in particular in the neocortex. In artificial neural networks, the recurrent interconnection of model neurons is used to discover temporally encoded information in the data. Examples of such recurrent neural networks are the Elman network, the Jordan network, the Hopfield network and the fully interconnected neural network. A convolutional neural network (CNN or ConvNet) is an artificial neural network. It is a concept in the field of machine learning inspired by biological processes. Convolutional neural networks are used in numerous artificial intelligence technologies, primarily in the machine processing of image or audio data.

Recurrent or feedback neural networks are neural networks which, in contrast to feedforward networks, are characterized by connections between neurons in one layer and neurons in the same or a previous layer. In the brain, this is the preferred way of connecting neural networks, especially in the neocortex. In artificial neural networks, the recurrent interconnection of model neurons is used to discover temporally encoded information in the data. Examples of such recurrent neural networks are the Elman network, the Jordan network, the Hopfield network and the fully interconnected neural network.

In a further development of the invention, a process instruction comprises a geometric start (x, y, z) and a geometric end point (x, y, z) for each individual vector (exposure vector). In an optional development according to the invention, the laser power and/or the laser speed are included in a process instruction. In a further embodiment of the invention, a process instruction has one or more elements of the following group of parameters: type of vector (fill, contour vector; overhang vector, surface vector), polygon that describes the outer boundaries of the part, start/end time of each vector, pause times between the vectors (forced (e.g.) for cooling or due to optical/mechanical conditions (so it can't go any faster)), pause times between the layers, coating times and information, build plate temperature, assignment of which vector is written by which laser, regions that the individual lasers can reach, continuous or pulsed vector, focus of the laser and which laser mode (per vector), rarely: circular movements of the laser (wobble) and/or information about the gas used and its direction of flight in the build chamber.

In a further embodiment of the invention, the ML (machine learning) algorithm is applied to an initial process instruction. In a further embodiment of the invention, the initial process instruction is created without an ML algorithm.

The method according to the invention creates an initial process instruction for the additive manufacturing of a first building structure and a process instruction for the additive manufacturing of a second building structure, wherein the initial process instruction is created without an ML algorithm and the process instruction is created by means of an ML algorithm. The two building structures preferably have the same component but different support structures. Using both process instructions, one and the same component can be manufactured, wherein the process instruction is created on the basis of the initial process instruction. The initial process instruction is optimized using an ML algorithm in such a way that the component manufactured using the process instruction has an improved residual stress distribution and/or an improved temperature distribution, for example to avoid local and/or global overheating.

In a further embodiment of the invention, ML data is read from a database for the use of the ML algorithm. ML data is data that is used by an ML algorithm to create a process instruction. These data are stored in a database which is separate in a further development of the invention.

A computer unit within the meaning of the invention includes all electronic devices with data processing properties. A computer unit is therefore, for example, a personal computer, server, handheld computer system, pocket PC device, mobile phone device and other communication device that can process data in a computer-aided manner, as well as processors and other electronic devices for data processing, which can also be connected to form a network. A computer unit also includes or is connected to a storage unit. The storage unit is optionally designed as a database and can also optionally be arranged separately from the computer unit.

In a further embodiment of the invention, the ML data contains data from different manufacturing processes for additive manufacturing. The ML data is created for different CAM methods, where CAM methods include laser and/or electron beam powder bed fusion, direct energy deposition (DED) binder jetting, fused filament fabrication (FFF), melt filament printing and/or other non-abrasive computer-aided manufacturing processes that rely on a tool path with process parameters assigned to it. Different additive manufacturers use different CAM methods to produce a component. The data includes the possible process parameters of the additive manufacturer, the possible travel speeds, and the possible travel paths of the component to the additive manufacturer. The data is different for different additive manufacturers and is therefore used to create the process instruction. At the same time, it is possible to create process instructions for different additive manufacturers; the method according to the invention can therefore be applied to different additive manufacturers.

In an advantageous embodiment of the invention, experimental data and/or simulation data are used for the application of the ML algorithm. In a further development of the invention, the experimental data include the local temperature, power of the energy beam, irradiation time of individual vectors, pause time between the irradiation times of individual vectors and/or the travel speed of the energy beam. Experimental data comprises data obtained experimentally. The experimental data comprises data of a building structure acquired in-situ in real time and/or in previous manufacturing processes. With the experimental data, the creation of the process instruction can include data detected based on real, non-simulated manufacturing processes. In a further aspect of the invention, calculated data are determined from the experimental data.

In a further embodiment of the invention, experimental data are recorded in-situ during the execution of a first part of the process instruction for manufacturing a first portion of the component in an advantageous embodiment of the invention. In a preferred variant of the invention, a first portion of the component can be manufactured additively by means of the process instruction. The process instruction is therefore an initial process instruction, in other words a first part of the process instruction with which a first portion of the component can be manufactured additively. The entire component can be manufactured using the process instruction. The first portion of the component is, for example, a layer; the first part of the process instruction accordingly includes a process instruction for the additive manufacturing of the first layer of the component. The first portion can also include a sequence of several layers or parts of layers.

To acquire the experimental data, preferably during the production of the component in real time, different methods and detection devices can be used, e.g. the detection device is a temperature detection device configured to measure an irradiation point temperature of the component, an imaging device configured to measure a light emission quantity in order to detect a generated spray or atomization quantity, an imaging device configured to acquire a form surface image of the component or an imaging device configured to detect a melt pool size.

In a further advantageous embodiment of the invention, a second part of the process instruction for the production of the component is created from the experimental data recorded in-situ during the execution of the process instruction. The acquired experimental data are sent to the second storage device and also stored in the second storage device. These experimental data are read in and calculated data are determined from the experimental data. The ML algorithm is applied to this calculated data and a second part of the process instruction is created during the execution of the initial process instruction.

In a further embodiment of the invention, the second part of the process instruction is created for the production of a second portion of the component. In a further embodiment of the invention, the second part of the process instruction has parameters for the production of the second portion of the component which are modified compared to the initial process instruction. In a further embodiment of the invention, the changed parameters comprise one or more parameters from the group of power of the energy beam, irradiation time of individual vectors, pause time between the irradiation times of individual vectors, travel speed of the energy beam, change in the hatch distance between the vectors, the vector sequence, the vector length, vector orientation and/or changed geometry of the support structure.

This process is repeated until all portions of the component are manufactured. Following the generation of the second process instruction for the additive manufacturing of a second layer of the component, a third process instruction for the additive manufacturing of a third layer of the component is generated using the ML algorithm, and so on, with each n-th process instruction being created on the basis of the (n-1)th process instruction using the ML algorithm.

In a further embodiment of the invention, the initial process instruction was created on a first computer unit and the process instruction is created on a second computer unit, wherein the first computer unit is different from the second computer unit. The two different computer units preferably also differ in their location and, particularly, in the access rights that a user has to the computer units. Preferably, a user with access rights to the second computer unit can transfer these process instructions, e.g. those created by the user himself, which are used by the second computer unit to create a process instruction. The method according to the invention therefore enables users to access a computer unit to create a process instruction that is optimized with regard to its residual stress distribution.

In a further development of the invention, the initial process instruction was created with a first software program and the process instruction is created with a second software program, wherein the first software program is different from the second software program. The formalized processes of the two different methods are implemented and processed using different software. In a further embodiment of the invention, the method executed by the first software is different from the method executed by the second software. The second software uses an ML and/or AI algorithm to create the second process instruction, which is different from the first software used to create the first process instruction. The first software optionally does not use any ML and/or AI algorithm.

In a further development of the invention, the first building structure is different from the second building structure. In a further embodiment of the invention, the first building structure comprises the component and a first support structure, the second building structure comprises the component and a second support structure, wherein the first support structure is different from the second support structure. The two building structures preferably have the same component but different support structures. The same component can therefore be manufactured using the first and second process instructions, with the second process instruction being created on the basis of the first process instruction.

In a further embodiment of the invention, the initial process instruction is created using a first method, the process instruction is created using a second method, wherein the first method is different from the second method. A method within the meaning of the invention is a systematic and targeted approach for creating a process instruction for the additive manufacturing of a building structure using formalized processes. The formalized processes are defined, for example, in a computer program.

In a further embodiment of the invention, the first method for creating the initial process instruction comprises the use of a first software and the second method for creating the process instruction comprises the use of a second software, wherein the first software is different from the second software.

In a further development of the invention, the initial process instruction was created with a first software program and the process instruction is created with a second software program, wherein the first software program is different from the second software program. The formalized processes of the two different methods are implemented and processed using different software. In a further embodiment of the invention, the method executed by the first software is different from the method executed by the second software. The second software uses an ML and/or AI algorithm to create the second process instruction, which is different from the first software used to create the first process instruction. The first software optionally does not use any ML and/or AI algorithm.

In a further embodiment of the invention, the initial process instruction is created with the aid of a first data set. The first data set contains machine data of the additive manufacturer for which the initial process instruction is to be created, as well as component data, simulation data of the temperature distribution in the building structure during the manufacturing process and/or experimental data.

In a further aspect of the invention, the process instruction is created using a second data set. In a further embodiment of the invention, the first data set is different from the second data set. Preferably, the second data set contains empirical data. The empirical data includes data that was collected and created using one or more previous additive manufacturing processes of components or building structures as well as the process instructions specific to each component. The empirical data comprise machine data of the additive manufacturer for which the process instruction is to be created, as well as component data, simulation data of the temperature distribution in the building structure during the manufacturing process and/or experimental data.

In a further embodiment of the invention, the second data set comprises experimental data, component data, empirical data and/or machine data. In a further development of the invention, the second data set comprises experimental data, component data, empirical data and/or machine data from different additive manufacturing processes. In a further aspect of the invention, the second data set comprises experimental data, component data, empirical data and/or machine data of different additive manufacturers.

The machine data comprises the possible process parameters of the additive manufacturer, the possible travel speeds, and the possible travel paths of the component to the additive manufacturer. The machine data is different for different additive manufacturers and is therefore used to create the process instruction. At the same time, it is possible to create process instructions for different additive manufacturers; the method according to the invention can therefore be applied to different additive manufacturers.

The component data include the geometry of the building structure, the geometry of the component and/or material data, and wherein the material data include the phases, the concentration of the phases, the microstructure, the mechanical properties, the melting temperature and/or the boiling temperature. A building structure to be manufactured often includes thin-walled or overhanging structures. In these regions, the body provides a much smaller local thermal capacity, so that the structure can overheat locally using standard process parameters. This leads, for example, to undesirably large melt pools, which hinder the manufacturing process by forming large melt beads. For all possible combinations of process and material parameters, corresponding data must be stored in the database. In the individual application case, the appropriate data must be retrieved from the database and taken into account when calculating the temperature development.

The simulation data includes calculated data that was determined based on a model and one or more specified parameters. The simulation data contain data on a building structure in which the shrinkage and the formation of structural stresses are taken into account during the shaping process by producing a geometry of the building structure modified by means of the simulation process, which assumes the desired geometry of the building structure due to the stresses and shrinkages.

Experimental data comprises data determined experimentally. The experimental data comprises data of a building structure created in-situ in real time and/or in previous manufacturing processes. With the experimental data, the creation of the second process instruction can include data detected based on real, non-simulated manufacturing processes.

In an advantageous embodiment of the invention, the second data set is used for an ML/AI algorithm. In a further development of the invention, the process instruction is created using an ML/AI algorithm.

In a further embodiment of the invention, the data of the initial process instruction are transferred to the second computer unit, wherein the data of the initial process instruction include the building structure geometry, the component geometry, the irradiation path of an energy beam, the exposure vectors and/or the process parameters of the beam source and/or the process parameters for influencing the energy input into the building structure. The initial process instruction provides basic data and process parameters for the additive manufacturing of a building structure, which forms the basis for the creation of a process instruction. By means of the process instruction, a structure can be produced which does not overheat in particularly vulnerable regions during the manufacturing process and which has a lower residual stress distribution in the cooled and post-processed state, which is relevant, for example, in the production of turbine blades.

In a further development of the invention, the data of the initial process instruction are transferred to the second computer unit via a public network. Users have access to the public network. Users can transfer their own created process instructions to the public network and/or download process instructions stored on the public network from the public network. The process instructions created by the user can also have different file formats.

In a further embodiment of the invention, the data of the process instruction are transferred to the first computer unit. In a further aspect of the invention, the data of the process instruction are transferred to the first computer unit via a public network. The first computer unit optionally sends the data of the second process instruction to the additive manufacturer and the building structure is additively manufactured using the process instruction.

In a further embodiment of the invention, the second computer unit is suitable for reading initial process instructions in different data formats. The process instructions transferred by users to the public network can have different file formats, which are read in by the second computer unit and used to create the process instructions. In an alternative embodiment, the second computer unit is implemented in a cloud environment.

In a further embodiment of the invention, the second computer unit is suitable for creating process instructions in different data formats. The process instruction can also be read in by additive manufacturers of different designs and used to produce a building structure.

In a further development of the invention, the initial process instruction comprises the irradiation path of an energy beam, the exposure vectors, the process parameters of the beam source and/or the process parameters for influencing the energy input into the building structure.

Process parameters are all variables that influence the manufacturing process using additive manufacturing. Process parameters are all variables that influence the process. The additive manufacturer requires process parameters to produce the component, e.g. the height of the layers to be produced, the orientation of the vectors, i.e. the direction and length of the path that the tool describes on the surface of the component to be manufactured. The method according to the invention creates an initial process instruction and a process instruction for a specific material which is intended for processing by additive manufacturing. The process parameters used depend on the additive manufacturer used to produce the component.

The tool path usually consists of a plurality of consecutive vectors that are traversed by the additive manufacturer. The process instructions thus define a process control that is carried out by the additive manufacturer for additive manufacturing.

The warmer the already constructed building structure is, the slower the heat dissipation in the building structure occurs. The vector length influences the temperature development in that the repeated heating of neighboring points is spaced apart by a longer time due to the parallel position of successively exposed vectors. Another important influencing factor is the mass distribution around the vectors, as this directly influences the heat dissipation and thus the risk of overheating.

In a further embodiment of the invention, the method parameters for influencing the energy input into the building structure include the power of the energy beam, the irradiation times of individual vectors, the pause times between the irradiation times of individual vectors, the travel speed of the energy beam, the hatch distance between the vectors, the vector sequence, the vector length and/or the vector orientation. In this way, overheating in vulnerable regions of the component can be prevented. Process parameters are all variables that influence the manufacturing process using additive manufacturing.

In a further embodiment of the invention, the data of the initial process instruction are read in or input for creating the process instruction, wherein the data of the initial process instruction include the building structure geometry, the component geometry, the irradiation path of an energy beam, the exposure vectors and/or the process parameters of the beam source and/or the process parameters for influencing the energy input into the building structure. The initial process instruction provides basic data and process parameters for the additive manufacturing of a building structure, which forms the basis for the creation of a process instruction. By means of the process instruction, a building structure can be produced which does not overheat in particularly vulnerable regions during the manufacturing process and which has a lower residual stress distribution in the cooled and post-processed state, which is relevant, for example, in the production of turbine blades.

In a further embodiment of the invention, machine data of the additive manufacturer are read in and/or entered and/or used to create the process instruction, wherein the machine data include the possible process parameters of the additive manufacturer, the possible travel speeds, the possible travel paths of the component to the additive manufacturer. The machine data is different for different additive manufacturers and is therefore used to create the process instruction. At the same time, it is possible to create process instructions for different additive manufacturers; the method according to the invention can therefore be applied to different additive manufacturers.

In a further embodiment of the invention, the component data are read in and/or entered and/or used to create the process instruction, wherein the component data include the geometry of the building structure, the geometry of the component and/or material data, and wherein the material data include the phases, the concentration of the phases, the microstructure, the mechanical characteristics, the melting temperature and/or the boiling temperature. A building structure to be manufactured often includes thin-walled or overhanging structures. In these regions, the body provides a much smaller local thermal capacity, so that the structure can overheat locally using standard process parameters. This leads, for example, to undesirably large melt pools, which hinder the manufacturing process by forming large melt beads. For all possible combinations of process and material parameters, corresponding data must be stored in the database and/or in an ML model to predict process parameters, such as temperature. In the individual application case, the appropriate data and/or the appropriate ML model must be retrieved from the database and taken into account when calculating the temperature development, for example.

In a further embodiment of the invention, simulation data are read in and/or entered and/or used to create the process instruction, wherein the simulation data comprise calculated data that were determined on the basis of a model and set or predefined parameters. The simulation data contain data on a building structure in which the shrinkage and the formation of structural stresses are taken into account during the shaping process by producing a geometry of the building structure modified by means of the simulation process, which assumes the desired geometry of the building structure due to the stresses and shrinkages.

In a further embodiment of the invention, experimental data are read in and/or entered and/or used to create the process instruction, wherein the experimental data comprise experimentally determined data. The experimental data comprises data of a building structure acquired in-situ in real time and/or in previous manufacturing processes. With the experimental data, the creation of the second process instruction can include data detected based on real, non-simulated manufacturing processes.

In a further embodiment of the invention, process parameters of the second process instruction are determined using an ML and/or AI algorithm to create the second process instruction. The ML and/or AI algorithm can use different methods to determine the process parameters.

In a further embodiment of the invention, the ML and/or AI algorithm uses empirical data to determine the process parameters of the process instruction, wherein the empirical data comprises machine data, component data, simulation data and/or experimental data. The empirical data includes data that was acquired and created using one or more previous additive manufacturing processes of components or building structures as well as the process instructions specific to each component. This data is stored in a database. In the individual application case, the appropriate data must be retrieved from the database and used to calculate the temperature development using an ML and/or AI algorithm.

In a further development of the invention, the empirical data includes machine data from different additive manufacturers. In a further embodiment of the invention, the different additive manufacturers comprise additive manufacturers of different designs. In a further embodiment of the invention, the different additive manufacturers use different CAM processes to manufacture a component. The machine data comprises the possible process parameters of the additive manufacturer, the possible travel speeds, and the possible travel paths of the component to the additive manufacturer. The machine data is different for different additive manufacturers and is therefore used to create the second process instruction. At the same time, it is possible to create process instructions for different additive manufacturers, the method according to the invention can therefore be applied to different additive manufacturers.

In a further embodiment of the invention, the empirical data comprises data from different CAM processes, wherein CAM processes include laser and/or electron beam powder bed fusion, direct energy deposition (DED) binder jetting and/or other non-abrasive computer-aided manufacturing processes that rely on a tool path with process parameters assigned thereto. Such empirical data are used to create the process instruction; such a second process instruction can therefore be used for different CAM processes.

In an advantageous embodiment of the invention, the process instruction comprises, compared to the initial process instruction, changed values of the power of the energy beam, the irradiation times of individual vectors, the pause times between the irradiation times of individual vectors, the travel speed of the energy beam, the increase in the hatch distance between the vectors, the vector sequence, the vector length, and/or the vector orientation. By means of the process instruction, a building structure can be produced which does not overheat in particularly vulnerable regions during the manufacturing process and which has a lower residual stress distribution in the cooled and post-processed state. The building structure to be manufactured is therefore better protected from local and/or global overheating.

In a further embodiment of the invention, the building structure and/or the component manufactured according to the process instruction has mechanical characteristics that are different from those of a building structure and/or a component manufactured according to the initial process instruction. In a further aspect of the invention, the mechanical characteristics include the residual stress distribution in the building structure and/or the component. Advantageously, the component manufactured according to the process instruction has a minimized residual stress distribution. The mechanical characteristics of the component are significantly improved compared to previously known processes. By means of the method according to the invention, local overheating is avoided, the quality of the finished product is increased and the production yield is increased by producing less waste.

In a further embodiment of the invention, during the manufacturing process, a modified residual stress distribution is generated in the building structure manufactured according to the process instruction and/or in the component manufactured according to the process instruction compared to a building structure manufactured according to the initial process instruction and/or a component manufactured according to the initial process instruction. Advantageously, the component manufactured according to the process instruction has a minimized residual stress distribution. The mechanical characteristics of the component are significantly improved compared to previously known processes. By means of the method according to the invention, local overheating is avoided, the quality of the finished product is increased and the production yield is increased by producing less waste.

In a further embodiment of the invention, the building structure manufactured according to the process instruction has a different geometry compared to a building structure manufactured according to the initial process instruction. A geometry within the meaning of the invention is a spatial arrangement and includes properties such as angle, thickness and structure of the building structure. In a further development of the invention, the modified geometry comprises the geometry of the component. In a further aspect of the invention, the modified geometry comprises the geometry of the support structure. Preferably, the building structure manufactured according to the process instruction has a support structure whose geometry is modified compared to a building structure manufactured according to the initial process instruction, such that the support structure has different attachment points on the component, so that the residual stress distribution in the manufactured component is modified.

In a further embodiment of the invention, the first method accesses a first set of empirical data to create the initial process instruction, and the second method accesses a second set of empirical data to create the process instruction, wherein the first set of empirical data is different from the second set of empirical data. The first set of empirical data includes data that was acquired and created using one or more previous additive manufacturing processes of components or building structures as well as the process instructions specific to each component. The empirical data comprise machine data of the additive manufacturer for which the initial process instruction is to be created, as well as component data, simulation data of the temperature distribution in the building structure during the manufacturing process and/or experimental data. The second set of empirical data includes the additive manufacturer's machine data, component data, simulation data and/or experimental data to determine the process parameters of the process instruction.

In a further embodiment of the invention, the first set of empirical data is stored on a first storage device and the second set of experience data is stored on a second storage device, wherein the first storage device is different from the second storage device. In the context of the invention, a storage device is understood to mean, for example, a computer-readable memory in the form of a random-access memory (RAM) or a hard disk. Cloud storage is also possible.

In a further embodiment of the invention, the additive manufacture of a component comprises CAM processes, wherein CAM processes include laser and/or electron beam powder bed fusion, direct energy deposition (DED) binder jetting and/or other non-abrasive computer-aided manufacturing processes that rely on a tool path with process parameters assigned thereto. The method according to the invention for creating a process instruction and the created process instruction can therefore be used for different CAM processes.

Exemplary embodiments of the method according to the invention for creating a process instruction for additive manufacturing of a component are shown schematically in the drawings in a simplified manner and are explained in more detail in the following description.

In the figures:

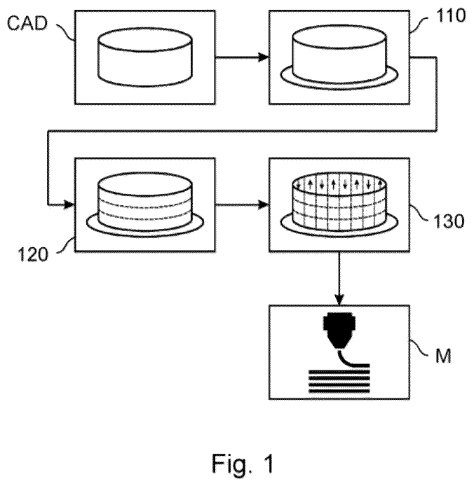

FIG. 1 shows a method from the prior art for providing a process instruction

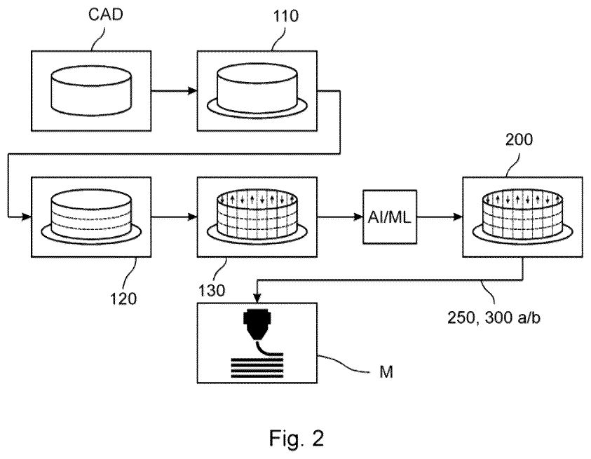

FIG. 2 shows a method according to the invention for providing a process instruction

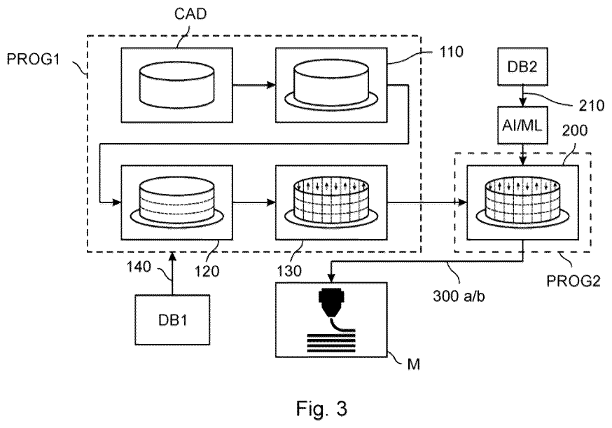

FIG. 3 shows a method according to the invention for providing a process instruction, two different software programs

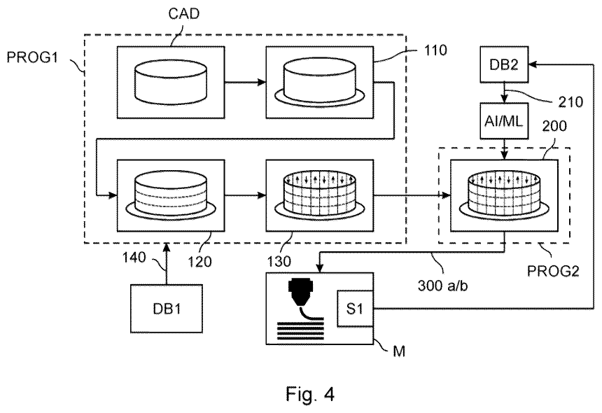

FIG. 4 shows a method according to the invention for providing a process instruction, two different software programs and manufacturing a first portion of the component

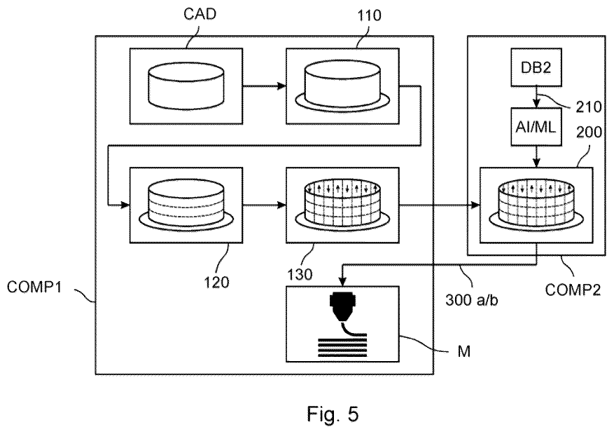

FIG. 5 shows a method according to the invention for providing a process instruction, two different computer units

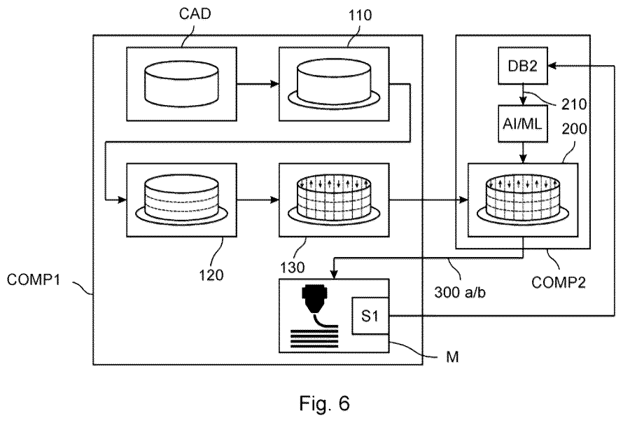

FIG. 6 shows a method according to the invention for providing a process instruction, two different computer units and manufacturing a first portion of the component

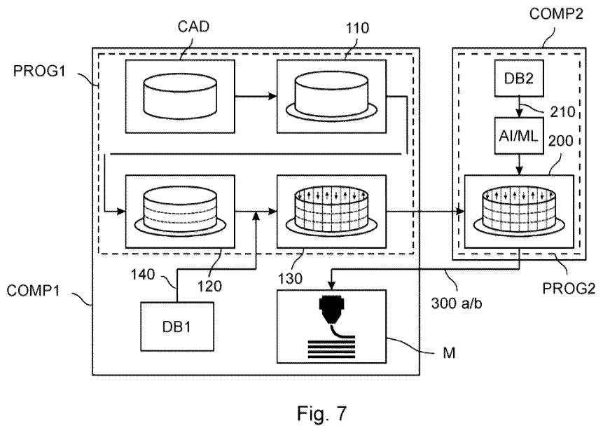

FIG. 7 shows a method according to the invention for providing a process instruction, two different computer units and two different software programs

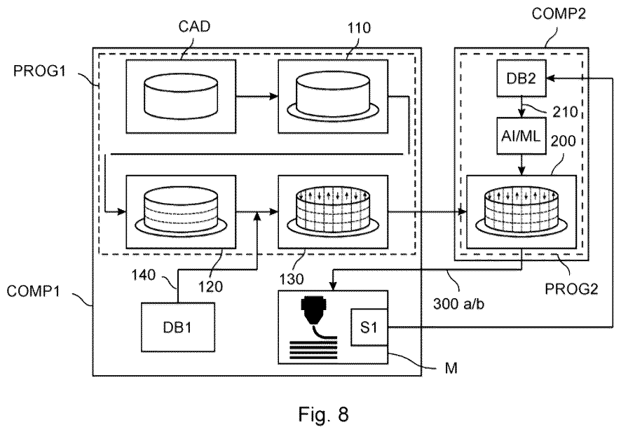

FIG. 8 shows a method according to the invention for providing a process instruction, two different computer units, two different software programs and manufacturing a first portion of the component

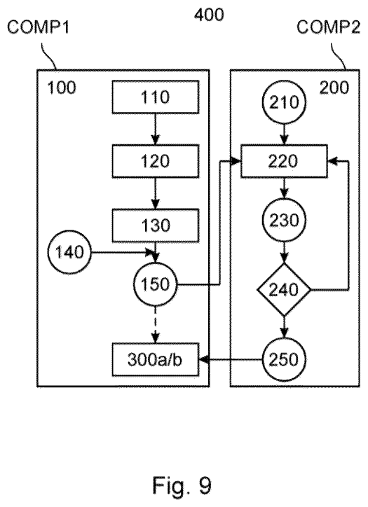

FIG. 9 shows a flowchart of the method according to the invention for providing a process instruction, separate computer units

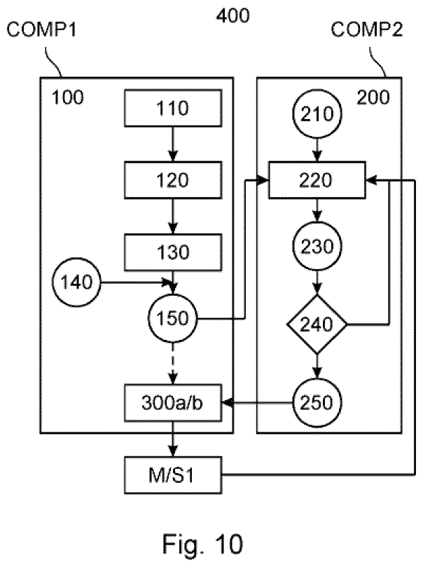

FIG. 10 shows a flowchart of the method according to the invention for providing a process instruction, separate computer units and manufacturing a first portion of the component

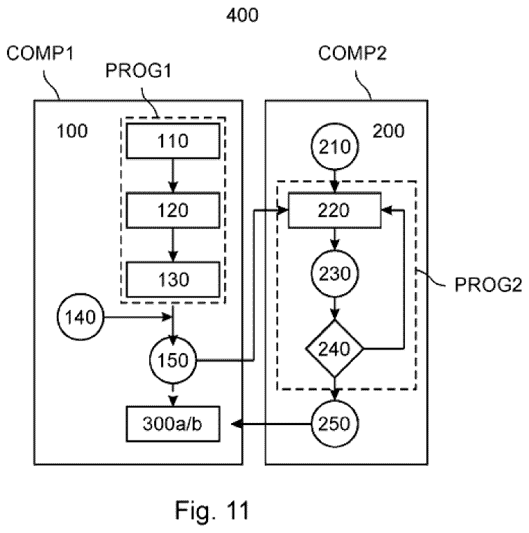

FIG. 11 shows a flowchart of the method according to the invention for providing a process instruction, separate computer units and separate software programs

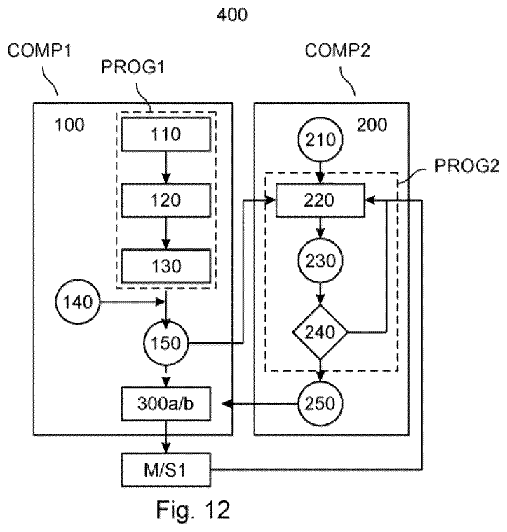

FIG. 12 shows a flowchart of the method according to the invention for providing a process instruction, separate computer units, separate software programs and manufacturing a first portion of the component

FIG. 1 shows an exemplary embodiment of a method for providing a process instruction as is known from the prior art. The starting point for additive manufacturing is a description of the workpiece using a data set. Using 3D modeling software (e.g. a CAD program), the data set for the building structure of the component to be manufactured is created CAD. The dataset contains the three-dimensional data for a preparation for production using the additive manufacturing process.

This is followed by pre-processing 110 on the build platform such that the data set comprises a volume model of the component to be manufactured and is exported into another form that represents the self-contained surface geometry of the object. From the data set a manufacturing data set is generated which contains a preparation of the geometry of the workpiece in layers or slices suitable for additive manufacturing. This transformation of the data is called slicing 120.

In addition, the additive manufacturer requires additional process parameters and tool paths for manufacturing, e.g. the height of the layers to be produced, the orientation of the writing vectors, i.e. the direction and length of the path. These process parameters and tool paths are generated in the following process step 130 and sent to the additive manufacturer 300a/b. In the actual manufacturing process M, the structure described using a CAD process CAD is additively manufactured layer by layer in the additive manufacturer using a CAM process.

An exemplary embodiment of the method according to the invention for providing a process instruction is shown in FIG. 2. In this and all following exemplary embodiments, a process instruction is created in order to produce a building structure by means of Directed Energy Deposition (DED). In DED, a powder or wire is fed coaxially to a laser to form a molten or sintered layer on a substrate. In DED, support structures are often necessary to attach the parts to the build plate and to secure overhangs.

First, a 3D model of the workpiece is created using a data set that is created using a CAD program CAD. This is followed by pre-processing 110 on the build platform, followed by slicing 120. In the following process step, an initial process instruction is generated 100, wherein the data of the initial process instruction includes the building structure geometry, the component geometry and the process parameters for influencing the energy input into the building structure.

To create a process instruction 200, these data of the initial process instruction are read in 220, an ML algorithm AI/ML is applied to these data of the initial process instruction and used for the creation 200 of the process instruction.

In this and all other exemplary embodiments, an ML and/or AI algorithm AI/ML is used to create 200 the process instruction, which uses reinforcement learning. Reinforcement learning (RL) refers to a set of machine learning methods in which an agent independently learns a strategy to maximize received rewards. The agent is not shown which action is best in which situation, but rather receives a reward, which can also be negative, at certain times through interaction with its environment. Other possibilities include using an ML and/or AI algorithm that uses supervised learning or unsupervised learning or intermediate stages of supervised learning or unsupervised learning. Deep learning can also be used.

The process instruction is sent to the additive manufacturer 300a/b, and the building structure to be manufactured is additively manufactured using the process instruction M.

FIG. 3 and FIG. 4 each show an exemplary embodiment of the method according to the invention, wherein the initial process instruction is created 100 by means of a first method PROG1 and the process instruction is created 200 by means of a second method PROG2 which is different from the first method PROG1. The first method PROG1 and the second method PROG2 are formalized procedures that are defined in a first software program PROG1 and in a second software program PROG2. The two software programs PROG1, PROG2 are different from each other.

First, a 3D model of the workpiece is created using a data set that is created using a CAD program CAD. Subsequently, preprocessing 110 is carried out on the build platform using the first method PROG1, followed by slicing 120. In the following step, an initial process instruction is generated 100 by means of the first method PROG1, wherein the data of the initial process instruction comprise the building structure geometry, the component geometry and the process parameters for influencing the energy input into the building structure. These data and process parameters depend on the material of the building structure and on the CAM process that the additive manufacturer uses to produce the building structure or component. The initial process instruction is created without an ML algorithm.

For this purpose, the first method PROG1 accesses 140 a first set of empirical data stored on a first storage device DB1. The first set of empirical data includes data that was acquired and created using one or more previous additive manufacturing processes of components or building structures as well as the process instructions specific to each component. The empirical data comprise machine data of the additive manufacturer for which the initial process instruction is to be created, as well as component data, simulation data of the temperature distribution in the building structure during the manufacturing process and/or experimental data.

The data and process parameters of the first process instruction created using the first method PROG1 are read in by the second method PROG2 to create 200 the second process instruction.

Furthermore, to create 200 the process instruction, machine data of the additive manufacturer used to manufacture M the building structure or component are read in and/or entered 210 and used to create 200 the process instruction. The machine data comprises the possible process parameters of the additive manufacturer, the possible travel speeds, the possible travel paths of the component to the additive manufacturer.

Component data is also read in and/or entered 210 to create 200 the process instruction and used to create 200 the process instruction. The component data comprise the geometry of the building structure, the geometry of the component and/or material data, wherein the material data include the phases, the concentration of the phases with a given temperature profile, the microstructure, the mechanical properties, the melting temperature and/or the boiling temperature.

In addition, simulation data is read in and/or entered 210 to create 200 the process instruction. The simulation data includes calculated data that was determined based on a model and entered or specified parameters.

In addition, experimental data are read in and/or entered 210 to create 200 the process instruction. The experimental data include experimentally determined data and process parameters that are determined in real time during the manufacturing process M of the building structure and/or determined from previous manufacturing processes.

Machine data of the additive manufacturer, component data, simulation data and experimental data are stored on a second storage device DB2 and are loaded from this to create 200 the process instruction.

The process instruction contains process parameters, which are advantageously determined using an ML algorithm AI/ML. The ML algorithm uses empirical data to determine the process parameters of the second process instruction, wherein the empirical data comprises the machine data of the additive manufacturer, component data, simulation data and/or experimental data stored on the second storage device DB2.

The process instruction is sent to the additive manufacturer 300a/b (FIG. 3), and the building structure to be manufactured is additively manufactured using the process instruction M.

In a preferred variant of the invention, only a first portion of the component is additively manufactured M by means of the process instruction. The process instruction created as described is therefore an initial process instruction, in other words a first part of the process instruction with which a first portion of the component is additively manufactured M. In contrast, the entire component can be manufactured using the complete process instruction as generated in FIG. 3. In this and the following exemplary embodiments, the first portion of the component is a layer, and the first part of the process instruction is accordingly a process instruction for additive manufacturing M of the first layer of the component. The ML algorithm AI/ML is applied to the initial process instruction (FIG. 4).

The manufacturing region in which the building structure is additively manufactured has a detection device S1 (FIG. 4). By means of the detection device S1, in-situ experimental data of the manufacturing process are recorded in real time during the production of the first portion of the building structure. In this and the other embodiments, the detection device S1 has a temperature detection device which detects the temperature of the layer which is currently being additively applied. Further possibilities include imaging devices to record the melt pool sizes, a form surface image and/or the spray or atomization quantity. The experimental data acquired by means of the detection device S1 also include, for example, the power of the energy beam, irradiation time of individual vectors, pause time between the irradiation times of individual vectors, and/or the travel speed of the energy beam.

The acquired experimental data are sent to the second storage device DB2 and also stored in the second storage device DB2. These experimental data are read in by the second method PROG2 220, and calculated data are determined from the experimental data. The ML algorithm AI/ML is applied to these calculated data and during the execution of the initial process instruction a second part of the process instruction for the production M of a second portion of the component, i.e. a second layer of the component, is created 200. The second part of the process instruction has modified parameters for the production M of the second portion of the component compared to the initial process instruction. The modified parameters comprise one or more parameters from the group of power of the energy beam, irradiation time of individual vectors, pause time between the irradiation times of individual vectors, travel speed of the energy beam, change in the hatch distance between the vectors, the vector sequence, the vector length, vector orientation and/or changed geometry of the support structure.

This process is repeated until all portions, i.e. all layers of the component, have been manufactured. Following the generation of the second process instruction for the additive manufacturing of a second layer of the component, a third process instruction for the additive manufacturing of a third layer of the component is generated using the ML algorithm AI/ML, and so on, with each n-th process instruction being created on the basis of the (n-1)th process instruction using the ML algorithm AI/ML.

A further exemplary embodiment of the method according to the invention is shown in FIG. 5 and FIG. 6. Here, the initial process instruction is created 100 on a first computer unit COMP1 and the process instruction is created 200 on a second computer unit COMP2.

First, a 3D model of the workpiece is created on the first computer unit COMP1 using a data set created using a CAD program CAD. This is followed by pre-processing 110 on the build platform, followed by slicing 120. In the following process step, an initial process instruction is generated 100, wherein the data of the initial process instruction includes the building structure geometry, the component geometry and the process parameters for influencing the energy input into the building structure.

To create 200 a process instruction, these data of the initial process instruction are read in 220 by the second computer unit COMP2 and used to create 200 the process instruction. The process instruction is sent to the additive manufacturer 300a/b, and the building structure to be manufactured is additively manufactured using the process instruction M.

Using the initial process instruction created, preferably only a first portion of the component can be manufactured additively. By means of the detection device S1, in-situ experimental data of the manufacturing process are recorded in real time during the production of the first portion of the building structure (FIG. 6). The acquired experimental data are sent to the second computer device COMP2 and also stored in the second storage device DB2. These experimental data are read in 220 and calculated data are determined from the experimental data. The ML algorithm AI/ML is applied to these calculated data and a second part of the process instruction for the production M of a second portion of the component, i.e. a second layer of the component, is created 200.

This method is repeated until all portions of the component are manufactured. Following the generation of the second process instruction for the additive manufacturing of a second portion of the component, a third process instruction for the additive manufacturing of a third portion of the component is generated using the ML algorithm AI/ML, and so on, with each n-th process instruction being created on the basis of the (n-1)th process instruction.

FIG. 7 and FIG. 8 show the preferred embodiment of the method according to the invention. Here, the initial process instruction is created on a first computer unit COMP1 using a first method PROG1 100. The process instruction is created on a second computer unit COMP2 using a second method PROG2 200. The first computer unit COMP1 comprises the first storage device DB1, the second computer unit COMP2 comprises the second storage device DB2. In each case, the first method PROG1 is different from the second method PROG2, the first computer unit COMP1 is different from the second computer unit COMP2 and the first storage device DB1 is different from the second storage device DB2.

First, a 3D model of the workpiece is created using a data set that is created using a CAD program CAD. Subsequently, preprocessing 110 is carried out on the build platform using the first method PROG1, followed by slicing 120. In the following step, an initial process instruction is generated 100 by means of the first method PROG1 on the first computer unit COMP1, wherein the data of the initial process instruction comprise the building structure geometry, the component geometry and the process parameters for influencing the energy input into the building structure. These data and process parameters depend on the material of the building structure and on the CAM process that the additive manufacturer uses to produce the building structure or component.

For this purpose, the first method PROG1 accesses 140 a first set of empirical data stored on a first storage device DB1. The first set of empirical data includes data that was acquired and created using one or more previous additive manufacturing processes of components or building structures as well as the process instructions specific to each component. The empirical data comprise machine data of the additive manufacturer for which the initial process instruction is to be created, as well as component data, simulation data of the temperature distribution in the building structure during the manufacturing process and/or experimental data.

The data and process parameters of the first process instruction created using the first method PROG1 are read in by the second method PROG2 on the second computer unit COMP2 to create 200 the process instruction. Machine data of the additive manufacturer, component data, simulation data and experimental data are stored on a second storage device DB2 and are loaded 210 from this to create 200 the process instruction.

The process instruction contains process parameters, which are also determined using an ML algorithm. The ML algorithm uses empirical data to determine the process parameters of the process instruction, wherein the empirical data comprises the machine data of the additive manufacturer, component data, simulation data and/or experimental data stored on the second storage device DB2.

The process instruction is sent to the additive manufacturer 300a/b, and the building structure to be manufactured is additively manufactured using the second process instruction M (FIG. 7).

Using the initial process instruction created, preferably only a first portion of the component can be manufactured additively. By means of the detection device S1, in-situ experimental data of the manufacturing process are recorded in real time during the production of the first portion of the building structure (FIG. 8). The acquired experimental data are sent to the second computer device COMP2 and also stored in the second storage device DB2. These experimental data are read in 220 and calculated data are determined from the experimental data. The ML algorithm AI/ML is applied to these calculated data by means of the second method PROG2 and a second part of the process instruction for the production M of a second portion of the component, i.e. a second layer of the component, is created with the second method PROG2 200.

This method is applied until all portions, i.e. all layers of the component, have been manufactured using the second method PROG2. Following the generation of the second process instruction for the additive manufacturing of a second layer sequence of the component, a third process instruction for the additive manufacturing of a third layer. sequence of the component is generated using the ML algorithm AI/ML, and so on, with each n-th process instruction being created on the basis of the (n-1)th process instruction.

FIG. 9 and FIG. 10 show exemplary embodiments of a flowchart of the method 400 according to the invention. Initial process instruction and process instruction are created on separate and different computer units COMP1, COMP2 100, 200 (FIG. 9).

First, a 3D model of the workpiece is created using a data set that is created using a CAD program CAD. In this and the following exemplary embodiment, the CAD program is executed on a computer unit different from the first computer unit COMP1 and the second computer unit COMP2. The CAD model contains data describing the building structure to be manufactured. The data is provided in standardized file formats, for example as an STL file (STL: Standard Tessellation Language). This CAD data is read in by the first computer unit COMP1.

This is followed by pre-processing 110 on the build platform, followed by slicing 120. In the following process step, an initial process instruction is generated 130, which includes the building structure geometry, the component geometry and the process parameters for influencing the energy input into the building structure.

From a first database DB1, the first computer unit COMP1 then loads 140 a first set of empirical data which is stored on a first storage device DB1. In this and the following exemplary embodiment, the first memory device DB1 is arranged in the first computer unit COMP1. The first set of empirical data includes data that was acquired and created using one or more previous additive manufacturing processes of components or building structures as well as the process instructions specific to each component. The empirical data includes machine data of the additive manufacturer for which the initial process instruction is to be created. Using this empirical data, the initial process instruction is created 150 by generating the additive manufacturer's process parameters and tool paths.

Depending on the additive manufacturer's CAM method, the initial process instruction includes the irradiation path of an energy beam, the exposure vectors, the process parameters of the beam source and/or the process parameters for influencing the energy input into the building structure. The process parameters for influencing the energy input into the building structure include the power of the energy beam, the irradiation times of individual vectors, the pause times between the irradiation times of individual vectors, the travel speed of the energy beam, the hatch distance between the vectors, the vector sequence, the vector length and/or the vector orientation. The process parameters for influencing the energy input into the building structure depend on the material of the building structure.

The process parameters for influencing the energy input into the building structure, the irradiation path of an energy beam, the exposure vectors and the process parameters of the beam source of the initial process instruction are optionally sent to a public network CL 150 (FIG. 6) and optionally stored on a storage unit of the public network CL. Users have access to the public network CL. Users can transfer their own created process instructions to the public network CL and/or download process instructions stored on the public network CL from the public network CL. The process instructions created by the user can also have different file formats.

Optionally, this initial process instruction is sent to an additive manufacturer 300a/b and the building structure can be manufactured based on the first process instruction M. Using the first process instruction, a first building structure - i.e. a first component with a first support structure - can be produced.

Advantageously, the process instruction can be used to produce a second building structure that is different from the first building structure. The building structure that can be manufactured using the process instruction has mechanical characteristics that are different from those of a building structure manufactured using the initial process instruction and/or a component manufactured using the initial process instruction, wherein the mechanical characteristics of the building structure that can be manufactured using the process instruction have, in particular, a different, in particular minimized, distortion and improved residual stress distribution compared to the building structure that can be manufactured using the initial process instruction. The structure that can be manufactured using the process instruction therefore has a different geometry, particularly of the support structure and, if applicable, also of the component, compared to the structure that can be manufactured using the initial process instruction.

For this purpose, the process parameters for influencing the energy input into the building structure, the irradiation path of an energy beam, the exposure vectors and the process parameters of the beam source of the initial process instruction are read in 220 by a second computer unit COMP2, wherein the first computer unit COMP1 and the second computer unit COMP2 are arranged differently from one another and at a distance from one another. The process parameters for influencing the energy input into the building structure, the irradiation path of an energy beam, the exposure vectors and the process parameters of the beam source of the initial process instruction are read in 220 after they have been sent 150 from the first computer unit COMP1 to the second computer unit COMP2 (FIG. 9). In another embodiment, the process parameters for influencing the energy input into the building structure, the irradiation path of an energy beam, the exposure vectors and the process parameters of the beam source of the initial process instruction are read in 220, after being optionally sent to the public network CL by the first computer unit COMP1.

The second computer unit COMP2 is suitable for reading in initial process instruction in different data formats 220 and is also suitable for creating process instructions in different data formats.

The process instructions transferred by users to the public network CL can have different file formats, which are read in by the second computer unit COMP2 220 and used to create 200 the process instruction. In addition, machine data of the additive manufacturer, component data, simulation data and experimental data are read in and/or entered 210, which are stored on a second storage device DB2.

The process instruction contains process parameters, which are also determined using an ML algorithm AI/ML 230. The ML algorithm AI/ML uses empirical data to determine 230 the process parameters of the process instruction, wherein the empirical data comprises the machine data of the additive manufacturer, component data, simulation data and/or experimental data stored on the second storage device DB2. This is followed by a query 240 as to whether, due to the process parameters determined by means of the ML algorithm AI/ML, a lower distortion and, in particular, improved residual stress distribution and thus a minimized distortion in the building structure to be produced is achieved.

Using the initial process instruction created, preferably only a first portion of the component can be manufactured additively. By means of the detection device S1, in-situ experimental data of the manufacturing process are recorded in real time during the production of the first portion of the building structure (FIG. 10). The acquired experimental data are sent to the second computer device COMP2 and also stored in the second storage device DB2. These experimental data are read in 220 and calculated data are determined from the experimental data. The ML algorithm AI/ML is applied to these calculated data and a second part of the process instruction for the production M of a second portion of the component, i.e. a second layer of the component, is created 200.

This method is applied until all portions, i.e. all layers of the component, have been manufactured using the second method PROG2. Following the generation of the second process instruction for the additive manufacturing of a second layer sequence of the component, a third process instruction for the additive manufacturing of a third layer of the component sequence of the component is generated using the ML algorithm AI/ML, and so on, with each n-th process instruction being created on the basis of the (n-1)th process instruction.

The process parameters determined by means of the ML algorithm AI/ML are used in further iterations of the application of the second method as starting values for the application 230 of an ML algorithm AI/ML until a minimum of the residual stress distribution in the structure to be manufactured is determined. The process instruction therefore contains process parameters with which a structure with minimized residual stress distribution can be produced. The process instruction is sent to the additive manufacturer 300a/b, and the building structure to be manufactured is additively manufactured using the second process instruction M.

Alternatively, the ML algorithm is used to determine 230 a predictive model of the distortion and residual stress distribution in the structure to be manufactured using the empirical data loaded from the second database DB2 220. This predictive model is used by the second method PROG2 as a starting value for optimization algorithms. By means of the optimization algorithms, process parameters of the second process instruction are optimized by means of process steps 220 to 240 until a minimized distortion and optimized residual stress distribution in the structure to be produced is determined.

By means of the method 400 according to the invention, a process instruction for the additive manufacturing of a building structure is provided, with which a building structure can be produced by means of different CAM methods. The CAM methods comprise laser and/or electron beam powder bed fusion, direct energy deposition (DED) binder jetting, fused filament fabrication (FFF), melt filament printing and/or other non-abrasive computer-aided manufacturing processes that rely on a tool path with process parameters assigned to it.

FIG. 11 and FIG. 12 show preferred embodiments of flow diagrams of the method 400 according to the invention. The exemplary embodiments shown here correspond to the previous embodiments (see FIG. 9, FIG. 10), only the process steps of preprocessing on build platform 110, slicing 120 and generation of the process parameters and tool paths 130 are carried out on the first computer unit COMP1 by means of a first method PROG1, i.e. a first computer program PROG1. On the second computer unit COMP2, the process steps of reading in data from the initial process instruction 220, creating the process instruction including the data from the initial process instruction and applying 230 an ML algorithm AI/ML and querying 240 are carried out by means of a second method PROG2, i.e. a second computer program PROG2. The first PROG1 and the second computer program PROG2 are executed differently from each other. In contrast to the second computer program PROG2, the first computer program PROG1 does not have an ML algorithm AI/ML.

First, a 3D model of the workpiece is created using a data set that is created using a CAD program CAD. In this and the following exemplary embodiment, the CAD program is executed on a computer unit different from the first computer unit COMP1 and the second computer unit COMP2. The CAD model contains data describing the building structure to be manufactured. The data is provided in standardized file formats, for example as an STL file (STL: Standard Tessellation Language) or other implicit or explicit file formats. This CAD data is read in by the first computer unit COMP1.

This is followed by pre-processing 110 on the build platform, followed by slicing 120. In the following process step, an initial process instruction is generated 130, which includes the building structure geometry, the component geometry and the process parameters for influencing the energy input into the building structure.

From a first database DB1, the first computer unit COMP1 then loads 140 a first set of empirical data which is stored on a first storage device DB1. The first storage device DB1 is arranged in the first computer unit COMP1. The first set of empirical data includes data that was acquired and created using one or more previous additive manufacturing processes of components or building structures as well as the process instructions specific to each component. The empirical data comprise machine data of the additive manufacturer for which the initial process instruction is to be created. Using this empirical data, the initial process instruction is created 150 by generating the additive manufacturer's process parameters and tool paths.

Depending on the additive manufacturer's CAM method, the initial process instruction includes the irradiation path of an energy beam, the exposure vectors, the process parameters of the beam source and/or the process parameters for influencing the energy input into the building structure. The process parameters for influencing the energy input into the building structure include the power of the energy beam, the irradiation times of individual vectors, the pause times between the irradiation times of individual vectors, the travel speed of the energy beam, the hatch distance between the vectors, the vector sequence, the vector length and/or the vector orientation. The process parameters for influencing the energy input into the building structure depend on the material of the building structure.

The process parameters for influencing the energy input into the building structure, the irradiation path of an energy beam, the exposure vectors and the process parameters of the beam source of the initial process instruction are optionally sent to a public network CL 150 (FIG. 6) and optionally stored on a storage unit of the public network CL. Users have access to the public network CL. Users can transfer their own created process instructions to the public network CL and/or download process instructions stored on the public network CL from the public network CL. The process instructions created by the user can also have different file formats.

Optionally, this initial process instruction is sent to an additive manufacturer 300a/b and the building structure can be manufactured based on the first process instruction M. Using the first process instruction, a first building structure—i.e. a first component with a first support structure—can be produced.

Advantageously, the process instruction can be used to produce a second building structure that is different from the first building structure. The building structure that can be manufactured using the process instruction has mechanical characteristics that are different from those of a building structure manufactured using the initial process instruction and/or a component manufactured using the initial process instruction, wherein the mechanical characteristics of the building structure that can be manufactured using the process instruction have, in particular, a different, in particular minimized, distortion and improved residual stress distribution compared to the building structure that can be manufactured using the initial process instruction. The structure that can be manufactured using the process instruction therefore has a different geometry, particularly of the support structure and, if applicable, also of the component, compared to the structure that can be manufactured using the initial process instruction.

For this purpose, the process parameters for influencing the energy input into the building structure, the irradiation path of an energy beam, the exposure vectors and the process parameters of the beam source of the initial process instruction are read in 220 by a second computer unit COMP2, wherein the first computer unit COMP1 and the second computer unit COMP2 are arranged differently from one another and at a distance from one another. The process parameters for influencing the energy input into the building structure, the irradiation path of an energy beam, the exposure vectors and the process parameters of the beam source of the initial process instruction are read in 220 after they have been sent 150 from the first computer unit COMP1 to the second computer unit COMP2 (FIG. 9). In another embodiment, the process parameters for influencing the energy input into the building structure, the irradiation path of an energy beam, the exposure vectors and the process parameters of the beam source of the initial process instruction are read in 220, after being optionally sent to the public network CL by the first computer unit COMP1.

The second computer unit COMP2 is suitable for reading in initial process instructions in different data formats 220 and is also suitable for creating process instructions in different data formats.

The process instructions transferred by users to the public network CL can have different file formats, which are read in by the second computer unit COMP2 220 and used to create 200 the process instruction. In addition, machine data of the additive manufacturer, component data, simulation data and experimental data are read in and/or entered 210, which are stored on a second storage device DB2.

The process instruction contains process parameters, which are also determined using an ML algorithm AI/ML 230. The ML algorithm AI/ML uses empirical data to determine 230 the process parameters of the process instruction, wherein the empirical data comprises the machine data of the additive manufacturer, component data, simulation data and/or experimental data stored on the second storage device DB2. This is followed by a query 240 as to whether, due to the process parameters determined by means of the ML algorithm AI/ML, a lower distortion and, in particular, improved residual stress distribution in the building structure to be produced is achieved.

Using the initial process instruction created, preferably only a first portion of the component can be manufactured additively. By means of the detection device S1, in-situ experimental data of the manufacturing process are recorded in real time during the production of the first portion of the building structure (FIG. 10). The acquired experimental data are sent to the second computer device COMP2 and also stored in the second storage device DB2. These experimental data are read in 220 and calculated data are determined from the experimental data. The ML algorithm AI/ML is applied to these calculated data and a second part of the process instruction for the production M of a second portion of the component, i.e. a second layer of the component, is created 200.

This method is applied until all portions, i.e. all layers of the component, have been manufactured using the second method PROG2. Following the generation of the second process instruction for the additive manufacturing of a second layer sequence of the component, a third process instruction for the additive manufacturing of a third layer of the component is generated using the ML algorithm AI/ML, and so on, with each n-th process instruction being created on the basis of the (n-1)th process instruction.

The process parameters determined by means of the ML algorithm AI/ML are used in further iterations of the application of the second method as starting values for the application 230 of an ML algorithm AI/ML until a minimum of the residual stress distribution in the structure to be manufactured is determined. The process instruction therefore contains process parameters with which a building structure with minimized residual stress distribution can be produced. The process instruction is sent to the additive manufacturer 300a/b, and the building structure to be manufactured is additively manufactured using the second process instruction M.

By means of the method 400 according to the invention, a process instruction for the additive manufacturing of a building structure is provided, with which a building structure can be produced by means of different CAM methods. The CAM methods include laser and/or electron beam powder bed fusion, direct energy deposition (DED) binder jetting, fused filament fabrication (FFF), melt filament printing and/or other non-abrasive computer-aided manufacturing processes that rely on a tool path with process parameters assigned to it.

### LIST OF REFERENCE NUMERALS

CAD Creating a CAD model
COMP1 First computer unit
COMP2 Second computer unit
PROG1 First software
PROG2 Second software
CL Public network
AI/ML ML algorithm
DB1 First storage device
DB2 Second storage device
S1 Detection device
M Execution of the process instruction/additive manufacturing of the component
100 Creating the initial process instruction
110 Preprocessing on build plate/in process chamber
120 Slicing/Creating a layer structure
130 Generating the process parameters and tool paths
140 Reading in data from the first database
150 Generating process parameters and tool paths using data from the first database
200 Creating a process instruction
210 Reading in data from the second database
220 Reading in data from the initial process instruction
230 Creating the process instruction using the data from the initial process instruction and applying an ML algorithm
240 query
250 Sending the process instruction
300a/b Sending the process instruction to the additive manufacturer
400 Method for providing a process instruction for additive manufacturing of a component

1. A method (400) for providing a process instruction for the additive manufacturing (M) of a component with the steps:
reading in geometrical data of the component
producing (120) a layer structure of a building structure,
wherein the building structure comprises the component,
generating (200) a process instruction for the additive manufacturing of the building structure,
wherein the process instruction comprises one or more parameters from the group of power of the energy beam, irradiation time of individual vectors, pause time between the irradiation times of individual vectors, travel speed of the energy beam, change in the hatch distance between the vectors, the vector sequence, the vector length, vector orientation and/or changed geometry of the support structure,
wherein an ML algorithm (AI/ML) is used (230) to generate (200) the process instruction.

2. The method (400) for providing a process instruction for the additive manufacturing (M) of a component according to claim 1,
characterized in that
the building structure and/or the layer structure includes a support structure.

3. The method (400) for providing a process instruction for the additive manufacturing (M) of a component according to claim 1,
characterized in that
the ML algorithm (AI/ML) is applied to an initial process instruction (230).

4. The method (400) for providing a process instruction for the additive manufacturing (M) of a component according to claim 3,
characterized in that
the initial process instruction is created without ML algorithm (AI/ML) (100).

5. The method (400) for providing a process instruction for the additive manufacturing (M) of a component according to claim 1,
characterized in that
for the use (230) of the ML algorithm (AI/ML), ML data is read from a database (DB2).

6. The method (400) for providing a process instruction for the additive manufacturing (M) of a component according to claim 5,
characterized in that
the ML data is read in (210) from a separate database (DB2).

7. The method (400) for providing a process instruction for the additive manufacturing (M) of a component according to claim 5,
characterized in that
the ML data comes from different manufacturing processes for additive manufacturing.

8. The method (400) for providing a process instruction for the additive manufacturing (M) of a component according to claim 1,
characterized in that
for the use (230) of the ML algorithm (AI/ML) experimental data and/or simulation data are used.

9. The method (400) for providing a process instruction for the additive manufacturing (M) of a component according to claim 8,
characterized in that
the experimental data include the local temperature, power of the energy beam, irradiation time of individual vectors, pause time between the irradiation times of individual vectors and/or the travel speed of the energy beam.

10. The method (400) for providing a process instruction for the additive manufacturing (M) of a component according to claim 8,
characterized in that
calculated data are determined from the experimental data.

11. The method (400) for providing a process instruction for the additive manufacturing (M) of a component according to claim 1,
characterized in that
experimental data are recorded during the execution of a first part of the process instruction for the manufacturing (M) of a first portion of the component.

12. The method (400) for providing a process instruction for the additive manufacturing (M) of a component according to claim 11,
characterized in that
the experimental data are recorded in-situ.

13. The method (400) for providing a process instruction for the additive manufacturing (M) of a component according to claim 11,
characterized in that
during the execution of the process instruction, a second part of the process instruction for the manufacturing (M) of the component is created from the experimental data recorded in-situ.

14. The method (400) for providing a process instruction for the additive manufacturing (M) of a component according to claim 13,
characterized in that
the second part of the process instruction for the manufacturing (M) of a second portion of the component is created.

15. The method (400) for providing a process instruction for the additive manufacturing (M) of a component according to claim 13,
characterized in that
the second part of the process instruction has modified parameters for the manufacturing (M) of the same portion of the component compared to the process instruction.

16. The method (400) for providing a process instruction for the additive manufacturing (M) of a component according to claim 15,
characterized in that
the modified parameters comprise one or more parameters from the group of power of the energy beam, irradiation time of individual vectors, pause time between the irradiation times of individual vectors, travel speed of the energy beam, change in the hatch distance between the vectors, the vector sequence, the vector length, vector orientation and/or changed geometry of the support structure.

17. The method (400) for providing a process instruction for the additive manufacturing (M) of a component according to claim 1,
characterized in that
the initial process instruction was created on a first computer unit (COMP1) and
the process instruction is created on a second computer unit (COMP2)
wherein the first computer unit (COMP1) is different from the second computer unit (COMP2).

18. The method (400) for providing a process instruction for the additive manufacturing (M) of a component according claim 1,
characterized in that
the initial process instruction was created with a first software program (PROG1) and the process instruction is created with a second software program (PROG2)
wherein the first software program (PROG1) is different from the second software program (PROG2).
